(19) United States
(12) Patent Application Publication
(10) Pub. No.: US 2012/0188067 A1
(43) Pub. Date: Jul. 26, 2012

(54) Alarm Sound Activated Module for Remote Notification

(76) Inventor: Weihao Xiao, Corona, CA (US)

(21) Appl. No.: 13/355,567

(22) Filed: Jan. 23, 2012

Related U.S. Application Data
(60) Provisional application No. 61/435,746, filed on Jan. 24, 2011.
(60) Provisional application No. 61/440,047, filed on Feb. 7, 2011.
(60) Provisional application No. 61/496,572, filed on Jun. 14, 2011.

(51) Int. Cl. B60R 25/10

(52) U.S. Cl. 340/426.18

(57) ABSTRACT

An alarm sound activated module is to improve exist security alarm systems by providing a convenient and low cost way of instant alarm remote notifications for almost all exist alarm systems without such functions yet through the use of general available communication devices and networks. Said alarm sound module is capable of detecting exist alarm sound, sending corresponding signal to a near by communication device for establishing a path through available communication networks to notify a remote user of an alarm event. Said alarm systems can be any of existing type capable of generating alarm sound in the case of an alarm event and requiring not any specific connection and modification with said alarm sound activated module. Said communication devices can be any commonly available type without the need of any or with minimum modification to support said alarm remote notifications.

### RELATED APPLICATION

This non-provisional application claims the priority of:

U.S. Provisional Application No. 61/435,746, entitled “A system providing alarm notification through cellular network for an existing security alarm” filed Jan. 24, 2011.
U.S. Provisional Application No. 61/440,047, entitled “A Sound Activated Cellular Security Alarm for Remote Notification” filed Feb. 7, 2011.
U.S. Provisional Application No. 61/496,572, entitled “Alarm Sound Activated Remote Notification System” filed Jun. 14, 2011.

The entirety of which is expressly incorporated herein by reference.

### FIELD OF THE INVENTION

The present invention relates to security alarm system based on commonly available communication devices and networks, more particularly, providing systems and methods of alarm remote notification for an exist alarm system either without such functions, or requires the subscription of dedicated alarm monitoring services, through the use of general available communication devices and networks such as cellular phones, internet, telephones, cable services as well as voice and data links to improve the security of said exist alarms and reducing the cost of exist alarm remote notifications.

### BACKGROUND OF THE INVENTION

Security alarm system has long been used to monitor and report burglaries, fire, smoke, and similar alarm events. Traditional security alarm system uses standard telephone network to report the alarm upon the detection of alarm conditions. Standard phone lines may be unreliable, particularly because events such as intentional tampering, fires, and major calamities can compromise the physical communications infrastructure. To address the reliability issues, the alarm industry has developed methods of using cellular wireless path for communicating alarm events to remote users.

The prior art has provided various type of cellular based wireless methods for security alarm system.

U.S. Pat No. RE32,856 to Millsap; James W, (Feb. 7, 1989), disclose an alarm system with a controller connecting with alarm sensors to detect alarm condition, wherein said controller sends said detected signal to a cellular transceiver, wherein said cellular transceiver sends alarm notification to monitor center through cellular site.

U.S. Pat. No. 4,993,059 to Smith, et al. (Feb. 12, 1991), disclose an alarm system wherein a sensor to detect said alarm event, wherein a cellular radio transceiver generates a unique ID for automatically dialing the monitor station upon receipt of said alarm signal, wherein a regular telephone is in connection with said alarm system as backup.

U.S. Pat. No. 5,185,779 to Dop; Dennis B (Feb. 9, 1993), disclose a alarm system capable of detecting inoperativeness of landline telephone, coupling landline inoperativeness to an alarm communicator of a security alarm system, automatically switching the alarm notification over to a cellular transmission system upon the detection of the inoperativeness of a landline system.

U.S. Pat. No. 5,568,535 to Sheffer; Eliezer (Oct. 22, 1996), disclose an alarm system wherein a alarm receiver to receive digital input from sensor detecting emergency condition, wherein a alarm signal processing unit to send alarm detection output, wherein a controller to establish a call on cellular phone, wherein said cellular phone transmitting alarm signal through cellular network to monitor station. U.S. Pat. No. 6,011,967 to Wieck; Christopher P. (Jan. 4, 2000), disclose an alarm system wherein a control mean of response to receipt of sensor signal representing occurrence of predetermined event, wherein a cellular phone for establishing a radio channel with a predetermined telephone number in response to the receipt of said sensor signal representing the occurrence of said predetermined event when said cellular telephone is in said alarm mode, as well as to receive and sending audio with user's telephone.

U.S. Pat. No. 6,032,037 to Jeffers; John Michael (Feb. 29, 2000), disclose an alarm system wherein an alarm panel to receive signal from a plurality of sensors, processing said signal t determine whether an alarm condition exists, wherein said alarm panel including communication arrangement for communicating with remote monitoring station through cellular communication protocol.

U.S. Pat. No. 7,076,211 to Donner, legal representative, et al. (Jul. 11, 2006), disclose an alarm system wherein a wireless device to detect signal representing environmental state in the vicinity of the wireless device, comparing detected signal with programmed rules, and communicating with wireless network to modify said rules based on detected signal.

U.S. Pat. No. 7,085,551 to Bonner; Thomas Wayne (Aug. 1, 2006), disclose an alarm system wherein a control panel sending alarm signal to remote monitor center is capable of selectively relaying alarm signal to remote center via wireless device or landline based telephone.

All the above prior arts with cellular alarm remote notification functions have the common disadvantages that the cellular caller is not a standard cellular phone which requires specific design and integration into the alarm system and to match with the complicated standard public network, which in turn adds up the cost of entire system. That is why most of cellular alarm devices in market are provided with paid services from alarm monitor centers to recover the cost for the devices and installations.

On the other hand, the needs for the cellular communicator to be physically connected with the existing alarm panel box in the prior arts also require specific skills and technical information from said exist alarm manufactures which in general is not possible because of competitions.

Also, the needs of the cellular caller, or cellular phone, to connect directly to alarm sensors from prior arts is also difficult and impractical since general cellular phone is not designed to have that abilities.

Further more, there are many exist alarm system without remote notification because of the availabilities of technology and cost at the time of being installed. However, methods described in prior arts can't be used to these type of exist alarm systems without a complete re-installation of said alarm system, which is also impractical and waste.

All above reasons have prevented said prior arts as well as remote alarm notification to become popular.

Thus, it is the object of this invention to take advantage of now a days popular and low cost wire and wireless communication technology to provide instant and reliable alarm remote notification for those verity of exist alarm systems without such functions yet.

In present invention, a stand alone alarm sound activated module is used to pick up the sound of an exist alarm from an alarm event, sending corresponding signal to a nearby communication device through wire or wireless technology for establishing a remote notification link with a remote user through available communication networks.

### BRIEF DESCRIPTION OF THE DRAWINGS

For a better understanding of the principle and nature of the present invention, reference should be made to the following detailed description taken in connection with the accompanying drawings in which:

FIG. 1. A sound activated module capable of detecting exist alarm sound and sending signal to a cellular phone connected through a plug-in connector for alarm remote notification.

FIG. 2. A sound activated module capable of detecting exist alarm sound and sending signal to a cellular phone wirelessly for alarm remote notification.

FIG. 3. A sound activated module capable of detecting exist alarm sound and sending signal to a cellular phone through cellular headset for alarm remote notification.

FIG. 4. A sound activated module capable of detecting exist alarm sound and send signal to a cellular phone through wireless headset for alarm remote notification.

FIG. 5. A combination of sound module and cellular circuitry to detect exist alarm sound for alarm remote notification.

FIG. 6. A sound activated module capable of detecting exist alarm sound and sending signal to a computer through wire connector for alarm remote notification.

FIG. 7. A sound activated module capable of detecting exist alarm sound and sending signal to a computer wirelessly for alarm remote notification.

FIG. 8. A computer with built-in sound activated module capable of detecting exist alarm sound for alarm remote notification.

FIG. 9. A sound activated module capable of detecting exist alarm sound and sending signal to a telephone through wire connector for alarm remote notification.

FIG. 10. A sound activated module capable of detecting exist alarm sound and sending signal to a telephone wirelessly for alarm remote notification.

FIG. 11. A telephone with built-in sound activated module capable of detecting exist alarm sound for alarm remote notification.

FIG. 12. A business method of providing above alarm remote notification along with exist cellular services.

FIG. 13. A business method of providing above alarm remote notification along with exist internet services.

FIG. 14. A business method of providing above alarm remote notification along with exist telephone services.

### DETAILED DESCRIPTION

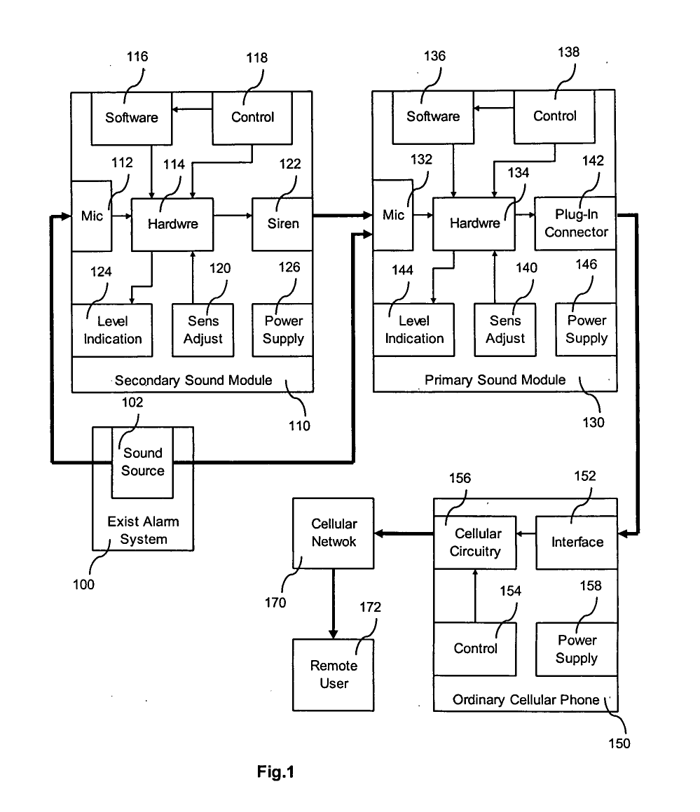

Referring to FIG. 1, a primary sound activated module 130 is capable of detecting the alarm sound from a protected premises of an exist alarm 100, sending corresponding signal to a commonly available cellular phone 150 through a plug-in connector 142 for establishing a phone call through a cellular network 170 to notify a remote user 172 of said alarm event without the requirement of any connection with said exist alarm 100 and any modification on both said exist alarm 100 and cellular phone 150.

Said exist alarm 100 can be any type of alarm, capable of creating alarm sound 102 in case of an alarm event, including but not limited to security alarm, smoke detector alarm, installed in-door or out-door, on vehicle, or used in any other protected premises. There is no requirement to connect said exist alarm 100 with the rest part of said application.

An optional secondary sound module 110, placed very close to said exist alarm 100, either attached to said alarm sound source 102, or placed on a near by desktop, wall or tope ceiling mounted, is capable of picking up said exist alarm sound 102 at different level and frequency, re-generating a secondary alarm sound 122 in a desired level and frequency for easy reception by other sound module 130 away from said exist alarm 100 for convenient and security purpose.

On said secondary sound module 110, there is at least one microphone 112 to detect said exist alarm sound 102 and converting it into electric signal. A combination of hardware 114 and optional software 116 is to perform process on said detected alarm signal such as amplification, frequency filtering, comparing with reference data to identify said alarm sound.

A siren 122 or speaker on said secondary sound module 110, driven by said hardware 114, is to re-generating a secondary alarm sound in response to said alarm event to notify a primary sound module 130. Said re-generated alarm sound can be adjusted to a proper level and frequency for easy reception by said primary sound module 130 at other convenient and securer location.

On said secondary sound module 110, there is an optional control method 118, a button or switch for example, to toggle manually between alarm or normal mode for power saving and preventing false alarm during disarmed period, or toggling automatically by recognition of the armed and disarmed sound from said exist alarm 100 to minimize usage care.

There are optional methods of alarm sound level indication 124 and detection sensitivity adjustment 120 based on measured alarm sound from said exist alarm 100 for effective detection of different type of alarm sound at different location. There is further an optional AC power supply 126 with indication of power condition to maintain the operation of said sound module, extend battery life and preventing frequently charging or replacing battery.

Said primary sound module 130, placed at proper location, for effectively detecting said exist alarm sound 102, or the re-generated alarm sound 122, has at least one microphone 132 to detect said alarm sound and optional background audio sound in case of an alarm event.

A combination of hardware 134 and optional software 136 is to perform process on said detected alarm signal such as amplification, frequency filtering, comparing with reference data to identify said alarm sound and generating control and audio signal to trigger said cellular phone 150 for alarm notification.

Most cellular phones are equipped with an interface, typically the hands-free interface, to receive initializing call and audio signal from a cellular headset. Said primary sound module 130 has a plug-in connector 142 capable of connecting with said cellular phone interface 152 to send said alarm detection signal to said cellular phone 150 for initializing an alarm call. Said plug-in connector 142 is made to match with the line configuration on said phone interface 152, the call initializing and audio lines for example, for properly signal routing.

On said primary sound module 130, there is an optional control method 138, a button or switch for example, to setup said user's ID, the phone number for example, as next to call number stored on said cellular phone 150. Said control method 138 can also be used for toggling between alarm or normal mode manually for power saving and preventing false alarm during disarmed period, or toggling automatically by detecting said armed and disarmed sound pattern from said exist alarm 100 to minimize usage care.

There is another option of alarm sound level indication 144 and detection sensitivity adjustment 140 based on measured alarm sound for effective detection of different type of alarm sound at different location.

There is further an optional AC power supply 146 with indication of power condition to maintain operation of said sound module, extend battery life and preventing frequently charging or replacing battery.

Said cellular phone 150 is a commonly available cellular phone with an interface 152, the hands-free interface for example, capable of communicating with said plug-in connector 142 from said sound module 130 to receive said alarm detection signal for establishing a phone call to said remote user 172.

A control method 154, the keypad for example, can be used to setup said remote user's ID, the phone number for example, into next to call list in case of an alarm event. Said cellular phone 150 is capable of sending said optional background audio signal to said remote user 172 for alarm event monitoring.

Upon detecting said alarm detection signal from said sound module 130, the cellular circuitry 156 on said cellular phone 150 is capable of establishing a phone call automatically through cellular network 170 to notify said remote user 172 of said alarm event.

Said remote user 172 can be an individual, a monitor center, a police station or any other user capable of receiving alert message from said cellular phone 150 through any communication network including but not limited to cellular, landline, internet, cable, voice or data link.

On said cellular phone 150, there is further an optional AC power supply 150 with indication of power condition to maintain operation of said alarm function, extend battery life and preventing the need of frequently charging or replacing battery, or even better to use regular battery instead of expensive rechargeable battery on regular cellular phone.

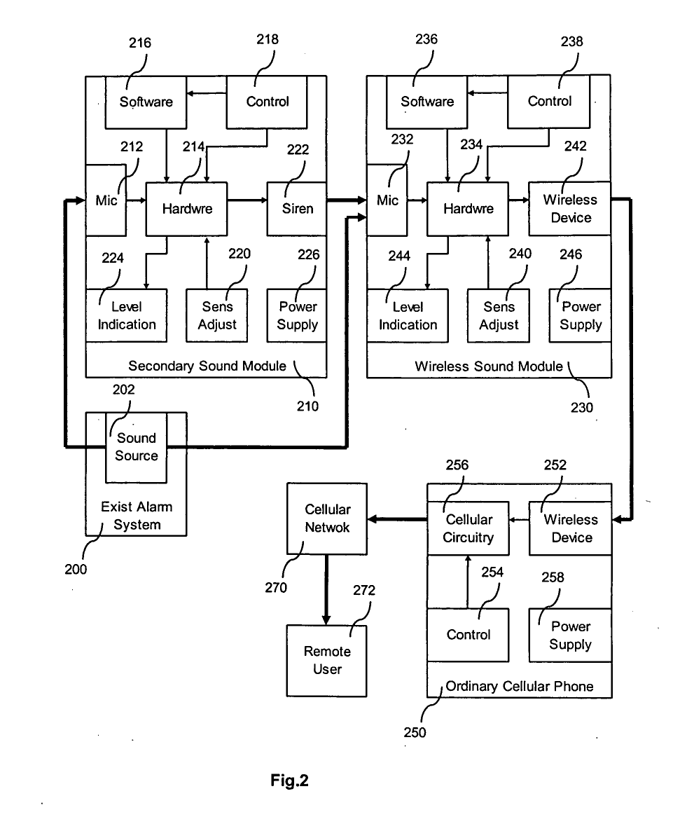

Referring to FIG. 2, A wireless sound module 230, is capable of detecting the alarm sound from a protected premises of an exist alarm system 200, communicating with a near by commonly available cellular phone 250 through wireless technique to send corresponding signal to said cellular phone 250 for establishing a call to notify a remote user 272 of an alarm event without the need of making specific connector to match with said phone interface on different type of cellular phones.

Said wireless sound module 230, placed at proper convenient location, for effectively detecting said exist alarm sound 202, or said re-generated alarm sound 222, has at least one microphone 232 to detect said alarm sound and optional background audio sound in case of an alarm event.

A combination of hardware 234 and optional software 236 is to perform process on said detected alarm signal from said microphone 232 such as amplification, frequency filtering, comparing with reference data to identify said alarm sound and generating control and audio signal to trigger said cellular phone 250 for alarm notification.

Many cellular phones are equipped with a built-in wireless device, Bluetooth or WiFi for example, to receive call initializing and audio signal from a wireless headset. Said wireless sound module 230 also has a wireless device 242 capable of communicating with said cellular phone 250 for sending said alarm detection signal to said cellular phone 250 to initialize a call in case of an alarm event.

On said wireless sound module 230, there is an optional control method 238, a button or switch for example, to setup said user's ID, the phone number for example, as next to call number stored on said cellular phone 250. Said control method 238 can also be used for toggling between alarm or normal mode manually for power saving and preventing false alarm during disarmed period, or toggling automatically through recognition of said armed and disarmed sound pattern from said exist alarm to minimize usage care.

There is another optional method of alarm sound level indication 244 and detection sensitivity adjustment 240 based on measured alarm sound for effective detection of different type of alarm sound at different location.

There is further an optional AC power supply 246 with power condition indication to maintain operation of said sound module, extend battery life and to prevent the need of frequently charging or replacing batteries.

Said cellular phone 250 is a commonly available cellular phone with a short range wireless device 252, Bluetooth or WiFi for example, capable of communicating with said wireless sound module 230 to receive said alarm detection signal for alarm notification.

A control method 254, the keypad on said cellular phone 250 for example, can be used to setup said remote user's ID, the phone number for example, into next to call list in case of an alarm event. Said cellular phone 250 is capable of sending said optional background audio signal to said remote user 272 for alarm monitoring. Upon detecting said alarm signal from said sound module 230, the cellular circuitry 256 on said cellular phone 350 is capable of establishing a phone call automatically through cellular network 270 to notify said remote user 272 of said alarm event. Said remote user 272 can be an individual, a monitor center, a police station or any other user capable of receiving alert message from said cellular phone through any communication network including but not limited to cellular, landline, internet, cable, voice or data link.

On said cellular phone 250, there is further an optional AC power supply 258 with indication of power condition to maintain operation of said cellular phone, extend battery life and to prevent the need of frequently charging or replacing batteries, or even better to use regular battery instead of expensive rechargeable battery on regular cellular phone.

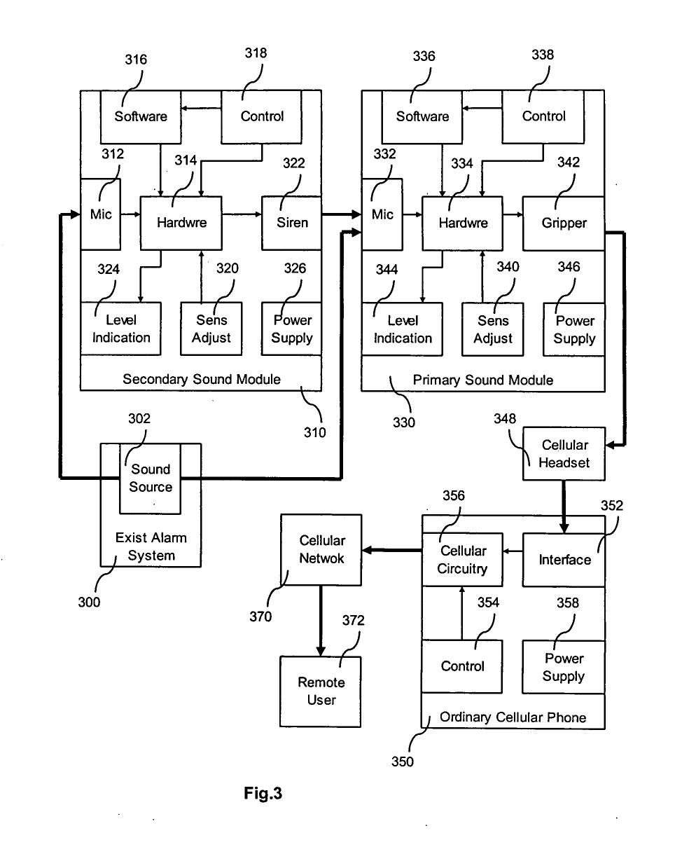

Referring to FIG. 3, A primary sound module 330, capable of detecting the alarm sound from a protected premises of an exist alarm system 300, is capable of communicating with a near by commonly available cellular phone 350 through a regular cellular headset 348 plugged into said cellular phone 350 for sending corresponding signal to establish a call to a remote user 372 for notifying said alarm event without the need of specially made wire or wireless devices to connect with said cellular phone 350.

Said primary sound module 330, placed at proper convenient location, for effectively detecting either said exist alarm sound 302, or said re-generated alarm sound 322, whichever is more effective, has at least one microphone 332 to detect said alarm sound and optional background audio sound in case of an alarm event, a combination of hardware 334 and optional software 336 to perform alarm sound recognition function such as amplification, frequency filtering, comparing detected alarm signal with reference data to identify said alarm sound and to generating corresponding control and audio signal for triggering an alarm call on said cellular phone 350.

In connection with said sound module 330 is a electro-mechanic device, a gripper 342 for example, driven by a mean of mechanic force, a motor or magnetic controlled by said alarm detection signal, for holding the body of said cellular headset 348 and to generate a press on the call/receive button in response to said alarm detection signal for initializing a call on said cellular phone 350 connected with said plugged-in headset to notify said remote user 372 of said alarm event, wherein said cellular headset 348 is capable of optionally picking up background audio sound for alarm monitoring.

On said primary sound module 330, there is an optional control method 338, a button or switch for example, to setup said user's ID, the phone number for example, as next to call number stored on said cellular phone 350. Said control method 338 can also be used for toggling between alarm or normal mode manually for the purpose of power saving and preventing false alarm during disarmed period, or toggling automatically through detecting said armed and disarmed sound pattern from said exist alarm 300 to minimize attention care.

There is another optional combination of alarm sound level indication 344 and sensitivity adjustment 340 for effectively detecting different type of alarm sound at different location.

There is further an optional extended AC power supply adaptor 346 with power condition indication to maintain operation of said sound module 330, extend battery life and to prevent the need of frequently charging or replacing batteries. Said cellular phone 350 is a commonly available cellular phone with an interface 352, the hands-free interface for example, capable of communicating with said plugged-in regular cellular headset 348 controlled by said sound module to receive said alarm detection signal for initializing an alarm call.

On said cellular phone 350, there is control method 354, the keypad for example, to setup said remote user's ID, the phone number for example, into next to call list in case of an alarm event. Said cellular phone 350 is optionally capable of sending said background audio signal to said remote user for monitoring said alarm event. Upon detecting said alarm detection signal from said sound module 330, the cellular circuitry 356 of said cellular phone 350 is capable of establishing a phone call automatically through cellular network 370 to notify said remote user 372 of said alarm event.

Said remote user 372 can be an individual, a monitor center, a police station or any other user capable of receiving alert message from said cellular phone through any communication network including but not limited to cellular, landline, internet, cable, voice or data link.

On said cellular phone 350, there is further an optional extended AC power supply adaptor 358 with indication of power condition to maintain operation of said cellular phone, extend battery life and to prevent the need of frequently charging or replacing batteries, or even better to use regular battery instead of expensive rechargeable battery on regular cellular phone.

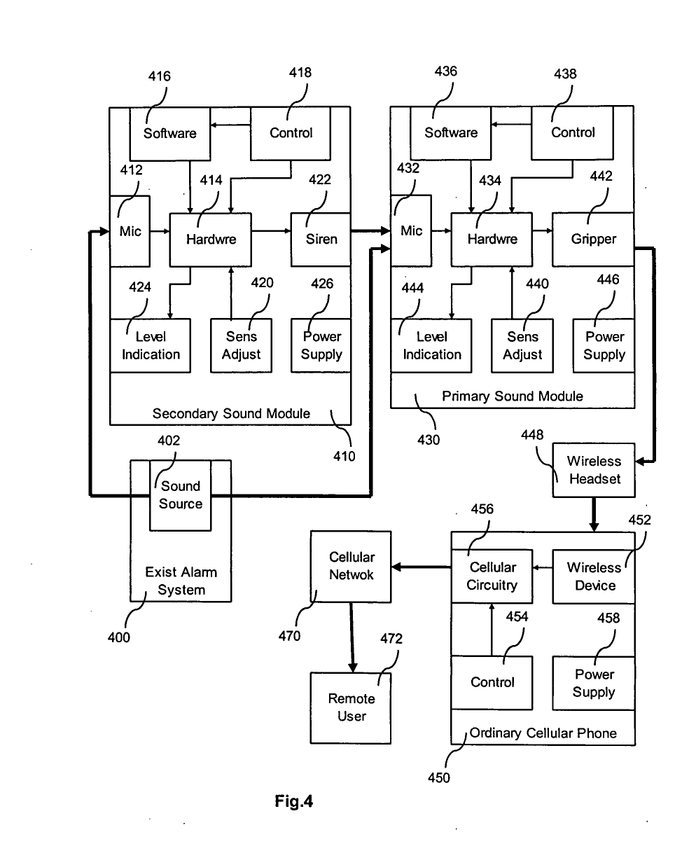

Referring FIG. 4, A primary sound activated module 430, capable of detecting the alarm sound from a protected premises of an exist alarm system 400, is capable of communicating with a near by commonly available cellular phone 450 through a regular wireless cellular headset 448 to send corresponding signal to said cellular phone 450 for establishing a call to a remote user 472 for notifying said alarm event to eliminate the need of specifically made wire or wireless connection to said cellular phone.

Said primary sound module 430, placed at proper convenient location, for effectively detecting either said exist alarm sound 402, or said re-generated alarm sound 422, whichever is more effective, has at least one microphone 432 to detect said alarm sound and optional background audio sound in case of an alarm event, a combination of hardware 434 and optional software 436 to perform alarm sound recognition function such as amplification, frequency filtering, comparing detected alarm signal with reference data to identify said alarm sound and to generating corresponding control and audio signal for triggering an alarm call on said cellular phone 450.

In connection with said sound module 430 is a electro-mechanic device, a gripper 442 for example, driven by a mean of mechanic force, a motor or magnetic controlled by said alarm detection signal, for holding the body of said wireless cellular headset 448 and generating a press on the call/receive button in response to said alarm detection signal for initializing a call through said cellular phone 450 equipped with similar wireless technique, Bluetooth or WiFi for example, to notify said remote user 472 of said alarm event, wherein said wireless headset 448 is capable of optionally picking up background audio sound for alarm monitoring. On said primary sound module 430, there is an optional control method 438, a button or switch for example, to setup said user's ID, the phone number for example, as next to call number stored in said cellular phone 450. Said control method 438 can also be used for toggling between alarm or normal mode manually for the purpose of power saving and preventing false alarm during disarmed period, or toggling automatically through detecting said armed and disarmed sound pattern from said exist alarm to minimize attention care.

There is another optional combination of alarm sound level indication 444 and sensitivity adjustment 440 for effectively detecting different type of alarm sound at different location.

There is further an optional extended AC power supply adaptor 446 with power condition indication to maintain operation of said sound module, extend battery life and to prevent the need of frequently charging or replacing batteries.

Said cellular phone 450 is a commonly available cellular phone with a short range wireless device 452, Bluetooth or WiFi for example, capable of communicating with said regular wireless cellular headset 448 controlled by said sound module 430 in order to receive said alarm detection signal for initializing an alarm call.

On said cellular phone 450, there is a control method 454, a keypad for example, to setup said remote user's ID, the phone number for example, into next to call list in case of an alarm event. Said cellular phone 450 is optionally capable of sending said background audio signal to said remote user for monitoring said alarm event.

Upon detecting said alarm detection signal from said headset 448 controlled by said sound module 430, said cellular phone 450 is capable of establishing a phone call automatically through cellular network 470 to notify said remote user 472 of said alarm event.

Said remote user 472 can be an individual, a monitor center, a police station or any other user capable of receiving alert message from said cellular phone 450 through any communication network including but not limited to cellular, landline, internet, cable, voice or data link.

On said cellular phone 450, there is further an optional extended AC power supply adaptor 458 with indication of power condition to maintain operation of said cellular phone, extend battery life and to prevent the need of frequently charging or replacing batteries, or even better to use regular battery instead of expensive rechargeable battery on regular cellular phone.

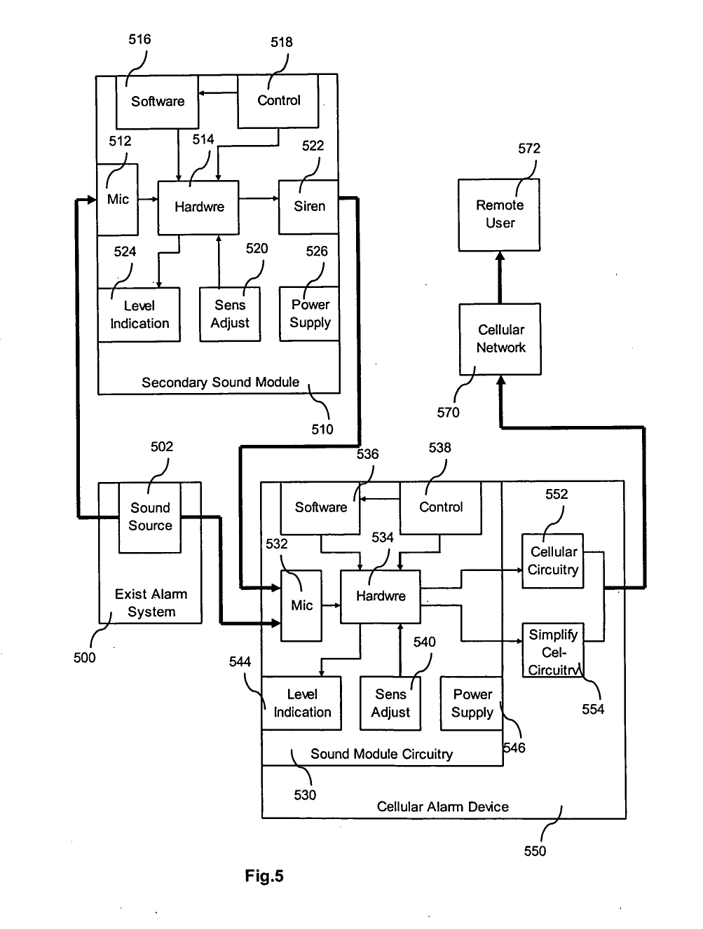

Referring FIG. 5, A cellular alarm device 550 combining both alarm sound module circuitry 530 and cellular circuitry 552 in one enclosure, is capable of detecting the alarm sound in the protected premises of an exist alarm system 500 and establishing a call for alarm remote notification without the need of requiring other wire or wireless supporting devices.

On said sound module circuitry 530, there is at least one microphone 532 to detect either said exist alarm sound 502 directly, or said re-generated alarm sound 522, as well as said optional background audio sound in case of an alarm event.

A combination of hardware 534 and software 536 is to process said detected signal from said microphone 532 such as performing amplification, frequency filtering and comparing with reference data to identify said alarm sound.

A control method 538, a keypad for example, is to setup said user's ID, the phone number for example, as next to call number in case of an alarm event. Said control method 538 can also be used for toggling between alarm or normal mode manually to save power consumption and preventing false detection to the surrounding noise during disarmed period, or toggling automatically through recognition of said armed and disarmed sound pattern to minimize usage care.

There is optional combination of alarm sound level indication 544 and detection sensitivity adjustment 540 based on measured said alarm sound for effectively detecting different type of alarm sound at different location.

There is further an optional extended AC power supply adaptor 546 with indication of power condition to maintain operation of said alarm function, extend battery life and to prevent the need of frequently charging or replacing batteries, or even better to use regular battery instead of expensive rechargeable battery on regular cellular phone.

Upon the detection of said alarm signal, said cellular circuitry 552 is capable of establishing a phone call automatically through cellular network 570 to notify said remote user 572 of said alarm event.

Said remote user 572 can be an individual, a monitor center, a police station or any other user capable of receiving alert message from said cellular phone through any communication network including but not limited to cellular, landline, Internet, cable, voice or data link.

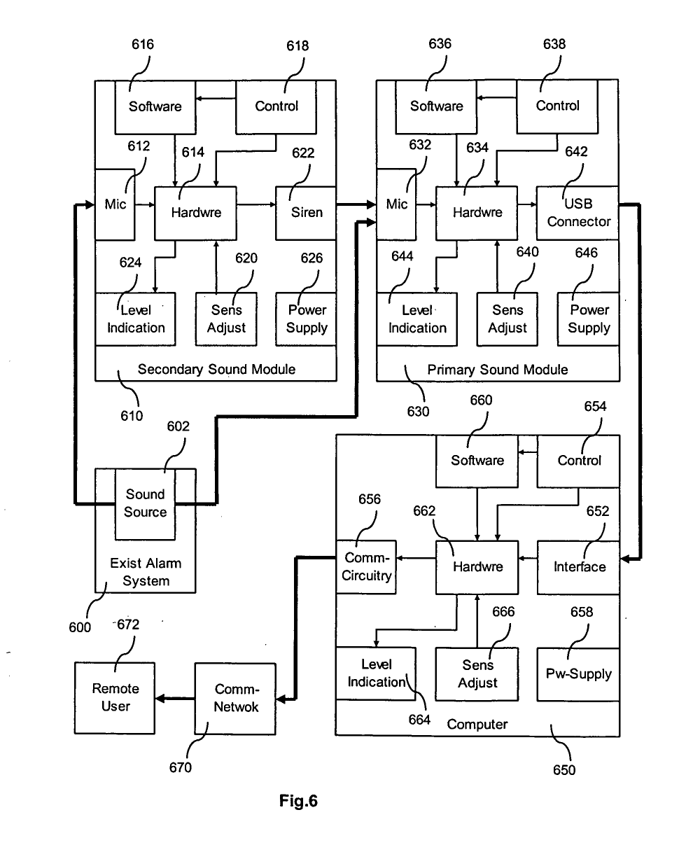

There is an important optional method of simplifying said cellular circuitry 554 for alarm notification purpose only to reduce the cost of device 550 and cellular network 570 by eliminating all unnecessary functions from a regular cellular phone including but limited to use specific alarm notification channel with narrower bandwidth, less traffic and higher priority, ignoring incoming call, and to use smaller phone screen. Referring FIG. 6, A sound activated module 630 is capable of detecting the sound from an exist alarm 600, connecting with a near by computer 650 through wire connection and sending corresponding signal to said computer for establishing a link to a remote user 672 for notifying said alarm event for the optimum usage of exist network service on said computer without need of subscribing additional network service for alarm notification.

Said primary sound module 630, placed at proper convenient location, for effectively detecting either said exist alarm sound 602, or said re-generated alarm sound 622, whichever is more effective, has at least one microphone 632 to detect said alarm sound and optional background audio sound in case of an alarm event.

A combination of hardware 634 and optional software 636 is to perform alarm sound recognition function such as amplification, frequency filtering, comparing detected alarm signal with reference data to identify said alarm sound and to generating corresponding control and audio signal for triggering an alarm notification on said computer 650.

There is a connector 642 on said sound module compatible with an interface 652 on said computer 650, the USB port for example, to receive supply power from and send said alarm detection signal to said computer for establishing a communication link 670 to notify a remote user 672 of said alarm event.

On said primary sound module 630, there is an optional control method 638, a button or switch for example, to toggle between alarm or normal mode manually for the purpose of power saving and preventing false alarm during disarmed period, or automatically toggling through detecting said armed and disarmed sound pattern from said exist alarm to minimize attention care.

There is another optional combination of alarm sound level indication 644 and sensitivity adjustment 640 based on measured alarm sound for effectively detecting different type of alarm sound at different location.

There is further an optional extended AC power supply adaptor 646 with power condition indication to maintain operation of said sound module, extend battery life and to prevent the need of frequently charging or replacing batteries.

Said computer 650 is either a standard computer, or a specific made one, with an interface 652, a USB port for example, to provide supply power to and communicating with sad sound module 630 to process said alarm detection signal from said sound module and establishing a link 670 for alarm remote notification. On said computer 650, there is a combination of hardware 662 and software 660 to perform processing on said detected alarm signal such as amplification, frequency filtering and comparing with reference data to identify said alarm sound.

There is another control method 654, through keyboard for example, to setting up remote user's ID, the phone number or IT address for example, as contact number in case of an alarm event, to toggle between alarm or normal mode to prevent false alarm manually, or automatically toggling through detecting armed and disarmed sound pattern from said exist alarm to prevent false alarm during disarmed period and to minimize usage care.

There is communication circuitry 656 for establish a communication link through a communication network to said remote user 672 to notify said alarm event upon the detection of said alarm signal, wherein said communication link 670 can be through any type of available communication network including but not limited to internet, cable, landline, cellular, voice or data link.

Said remote user 672 can be an individual, a monitor center, a police station or any other user able to receive alert message from said computer through any available communication network including but not limited to cellular, landline, internet, voice or data link;

There is an optional combination of alarm sound level indication 664 and detection sensitivity adjustment 666 based on measured alarm sound for effective detection of different type of alarm sound in different level, frequency pattern and in different location.

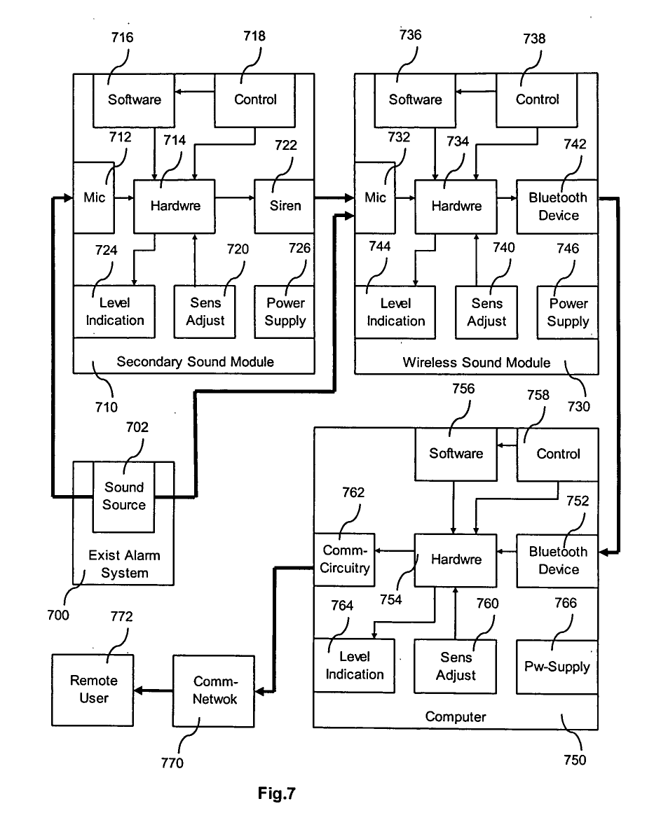

Referring to FIG. 7, A wireless sound activated module 730 is capable of detecting the alarm sound in the protected premises of an exist alarm system 700, connecting with a near by computer 750 through wireless technique for establishing a link to a remote user 772 for notifying said alarm event for the optimum usage of exist network service on said computer without need of subscribing additional network service for alarm notification and making physical connection to said computer 750. Said wireless sound module 730, placed at proper convenient location, for effectively detecting either said exist alarm sound 702, or said re-generated alarm sound 722, whichever is more effective, has at least one microphone 732 to detect said alarm sound and optional background audio sound in case of an alarm event.

A combination of hardware 734 and optional software 736 is to perform alarm sound recognition function such as amplification, frequency filtering, comparing detected alarm signal with reference data to identify said alarm sound and to generating corresponding control and audio signal for triggering an alarm notification on said computer 750.

There is a wireless device 742, including but not limited to Bluetooth, WiFi or other wireless technique on said sound module 730 to send said alarm detection signal to said computer 750 for establishing a communication link 770 to notify a remote user 772 of said alarm event.

On said wireless sound module 730, there is an optional control method 738, a button or switch for example, to toggle between alarm or normal mode manually for the purpose of power saving and preventing false alarm during disarmed period, or automatically toggling through detecting said armed and disarmed sound pattern from said exist alarm to minimize attention care.

There is another optional combination of alarm sound level indication 744 and sensitivity adjustment 740 for effectively detecting different type of alarm sound at different location.

There is further an optional extended AC power supply adaptor 746 with power condition indication to maintain operation of said sound module, extend battery life and to prevent the need of frequently charging or replacing batteries. Said computer 750 is either a standard computer, or a specific made one, with an short range wireless device 752, including but not limited to Bluetooth, WiFi or other technique, to communicate with sad sound module 730 to process said alarm detection signal and establishing a link for alarm remote notification.

On said computer 750, there is a combination of hardware 754 and software 756 to perform functions such as amplification, frequency filtering and comparing said alarm detection signal with reference data to identify said alarm signal from said sound module 730.

There is a control method 758, through keyboard for example, to setup remote user's ID, the phone number or IT address for example, as contact number in case of an alarm event, to toggle between alarm or normal mode manually, or toggling automatically based on detected armed and disarmed sound pattern from said exist alarm to prevent false alarm during disarmed period and to minimize attention care. Upon the detection of said alarm signal, a communication circuitry 762 on said computer 750 can automatically establishing a link through a communication network 770 to said remote user 772 to notify said alarm event, wherein said communication link can be through any type of available communication network 770 including but not limited to internet, cable, landline, cellular, voice or data link, wherein said remote user 772 can be an individual, a monitor center, a police station or any other user able to receive alert message from said computer through any available communication network including but not limited to cellular, landline, internet, voice or data link.

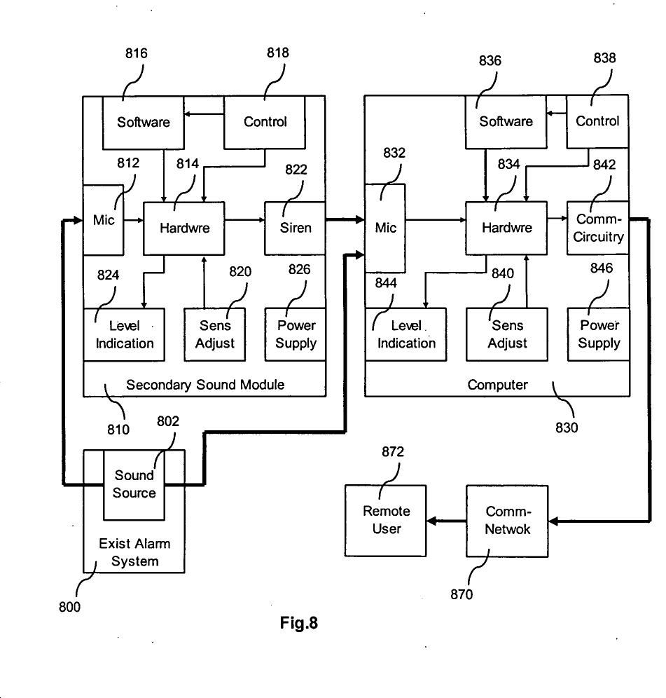

There is an optional combination of alarm sound level indication 764 and sensitivity adjustment 760 based on measured alarm sound for effective detection of different type of alarm sound in different level, frequency pattern and in different location. Referring to FIG. 8, A computer 830 with a built-in alarm sound detection function is capable of detecting the alarm sound from an exist alarm 800, processing said alarm detection signal to establish a link for alarm remote notification for the optimum usage of exist network service on said computer without need of subscribing additional remote network service and requiring other supporting devices. Said computer 830 is either a standard computer, or a specific made one, with at least one microphone 832 to detect either said exist alarm sound 802 directly, or said re-generated alarm sound 822, as well as said optional background audio sound in case of an alarm event.

There is a combination of hardware 834 and software 836 on said computer 830 to perform functions such as, amplification, frequency filtering and comparing said alarm detection signal with reference data to identify said alarm sound. A control method 838, through keyboard for example, is to setup remote user's ID, the phone number or IT address for example, as contact number in case of an alarm event, to toggle between alarm or normal mode manually, or automatically toggling based on detected armed and disarmed signal pattern from said exist alarm to prevent false alarm during disarmed period and to minimize attention care.

A communication circuitry 842, upon the detection of said alarm event, is capable of automatically establishing a communication link to said remote user 872 through a communication network 870 to notify said alarm event, wherein said communication link can be through any type of available communication network 870 including but not limited to internet, cable, landline, cellular, voice or data link.

Said remote user 872 can be an individual, a monitor center, a police station or any other user able to receive alert message from said computer through any available communication network including but not limited to cellular, landline, internet, voice or data link.

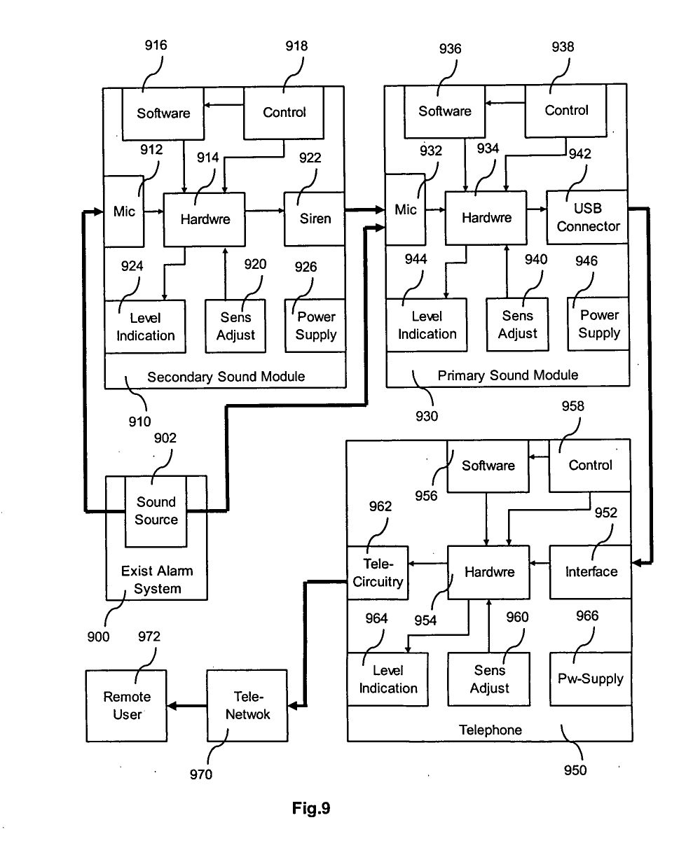

There is an optional combination of alarm sound level indication 844 and sensitivity adjustment 840 based on measured alarm sound for effective detection of different type of alarm sound in different level, frequency pattern and in different location. Referring to FIG. 9, A sound activated module 930 is capable of detecting the sound from an exist alarm 900, communicating with a near by telephone 950 through wire connection to send corresponding signal for establishing a link to a remote user 972 for notifying said alarm event for the optimum usage of exist telephone service without the need of subscribing additional remote network service for alarm notification.

Said primary sound module 930, placed at proper convenient location, for effectively detecting either said exist alarm sound 902, or said re-generated alarm sound 922, whichever is more effective, has at least one microphone 932 to detect said alarm sound and optional background audio sound in case of an alarm event.

A combination of hardware 934 and optional software 936 is to perform alarm sound recognition function such as amplification, frequency filtering, comparing detected alarm signal with reference data to identify said alarm sound and to generating corresponding control and audio signal for triggering an alarm notification on said telephone 950.

There is a wire connector 942 compatible with an interface 952 on said telephone 950, a USB port for example, to receive supply power from and send said alarm detection signal to said telephone 950 for establishing a communication link to notify a remote user 972 of said alarm event.

On said primary sound module 930, there is an optional control method 938, a button or switch for example, to toggle between alarm or normal mode manually for the purpose of power saving and preventing false alarm during disarmed period, or automatically toggling through detecting said armed and disarmed sound pattern from said exist alarm to minimize attention care.

There is another optional combination of alarm sound level indication 944 and sensitivity adjustment 940 based on measured alarm sound for effectively detecting different type of alarm sound at different location. There is further an optional extended AC power supply adaptor 946 with power condition indication to maintain operation of said sound module, extend battery life and to prevent the need of frequently charging or replacing batteries. Said telephone 950 is either a regular standard phone, or a specific made one, with an interface 952, a USB port example, to provide supply power to and communicating with sad sound module 930 to process said alarm detection signal from said sound module and establishing a link for alarm remote notification.

On said telephone 950, there is a combination of hardware 954 and software 956 to perform functions such as amplification, frequency filtering and comparing said alarm detection signal with reference data to identify said alarm sound.

A control method 958, through keypad for example, is to setup said remote user's ID, the phone number for example, as contact number in case of an alarm event, to toggle between alarm or normal mode for the purpose of power saving and preventing false alarm during disarmed period, or automatically toggling through detecting said armed and disarm sound pattern from said exist alarm to minimize attention care.

A telephone circuitry 962 is capable of automatically establishing a phone call through a telephone network 970 to said remote user 972 to notify said alarm event in responds to said alarm detection, wherein said phone network 970 call can be other type of available communication network including but not limited to internet, cable, landline, voice or data link.

Said remote user 972 can be an individual, a monitor center, a police station or any other user able to receive alert message from said telephone through any available communication network including but not limited to cellular, landline, internet, voice or data link.

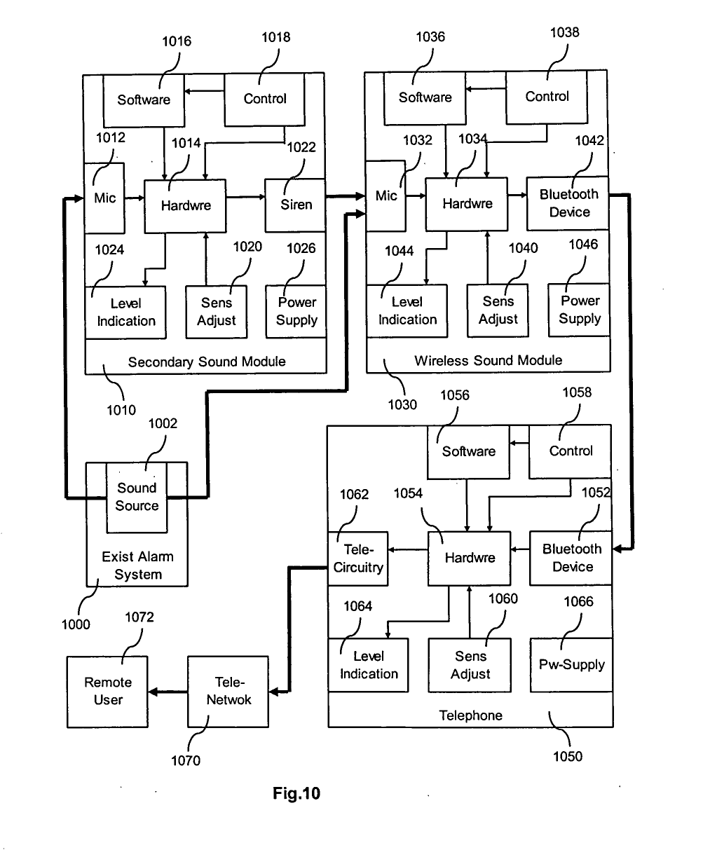

There is an optional combination of alarm sound level indication 964 and sensitivity adjustment 960 based on measured alarm sound for effective detection of different type of alarm sound in different level, frequency pattern and in different location. Referring to FIG. 10, A wireless sound activated module 1030 is capable of detecting the sound from an exist alarm 1000, connecting with a near by telephone 1050 through wireless technique and sending corresponding alarm detection signal to said telephone 1050 for establishing a link to a remote user 1072 for notifying said alarm event to without the need of subscribing additional remote network service other than exist phone service.

Said wireless sound module 1030, placed at proper convenient location, for effectively detecting either said exist alarm sound 1002, or said re-generated alarm sound 1022, whichever is more effective, has at least one microphone 1032 to detect said alarm sound and optional background audio sound in case of an alarm event.

A combination of hardware 1034 and optional software 1036 is to perform alarm sound recognition function such as amplification, frequency filtering, comparing detected alarm signal with reference data to identify said alarm sound and to generating corresponding control and audio signal for triggering an alarm notification on said telephone 1050.

There is a wireless device 1042, including but not limited to Bluetooth, WiFi or other technique on said sound module 1030 to send said alarm detection signal to said telephone 1050 for establishing a communication link to notify a remote user 1072 of said alarm event.

On said wireless sound module 1030, there is an optional control method 1038, a button or switch for example, to toggle between alarm or normal mode manually for the purpose of power saving and preventing false alarm during disarmed period, or automatically toggling through detecting said armed and disarmed sound pattern from said exist alarm 1000 to minimize attention care.

There is another optional combination of alarm sound level indication 1044 and sensitivity adjustment 1040 based on measured alarm sound for effectively detecting different type of alarm sound at different location.

There is further an optional extended AC power supply adaptor 1046 with power condition indication to maintain operation of said sound module, extend battery life and to prevent the need of frequently charging or replacing batteries.

Said telephone 1050 is either a regular landline phone, or a specific made one, with an short range wireless device 1052, including but not limited to Bluetooth, WiFi or other technique, to communicate with sad sound module 1030 to process said alarm diction signal and establishing a link for alarm remote notification.

On said telephone 1050, there is a combination of hardware 1054 and software 1056 to perform functions such as amplification, frequency filtering and comparing said alarm detection signal with reference data to identify said alarm sound.

A control method 1058, through keypad for example, is to setup remote user's ID, the phone number for example, as contact number in case of an alarm event, to toggle between alarm or normal mode for the purpose of power saving and preventing false alarm during disarmed period, or automatically toggling through detecting said armed and disarm sound pattern from said exist alarm to minimize attention care.

Upon detecting said alarm signal, the phone circuitry 1062 on said telephone 1050 is capable of automatically establishing a phone call through a telephone network 1070 to said remote user 1072 to notify said alarm event, wherein said phone call can be through other type of available communication network 1070 including but not limited to internet, cable, landline, voice or data link.

Said remote user 1072 can be an individual, a monitor center, a police station or any other user able to receive alert message from said computer through any available communication network including but not limited to cellular, landline, internet, voice or data link.

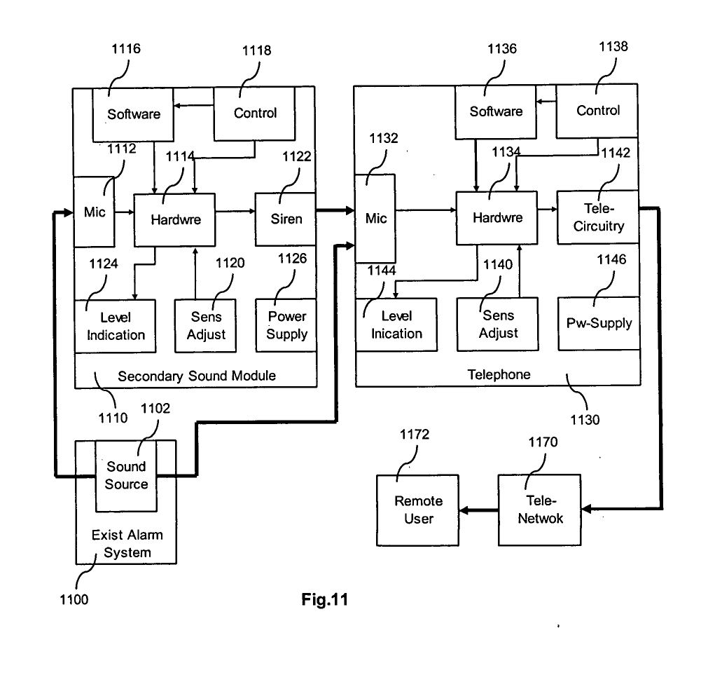

There is an optional combination of alarm sound level indication 1064 and sensitivity adjustment 1060 based on measured alarm sound for effective detection of different type of alarm sound in different level, frequency pattern and in different location. Referring to FIG. 11, A telephone 1130 with built-in sound activated module is capable of detecting the sound from an exist alarm 1100, processing said alarm detection signal to establish a link for alarm remote notification without the need of subscribing additional network service and requiring other supporting devices. Said telephone 1130 can be either a regular landline phone, or a specifically made type, to perform the task of controlling said sound module circuitry and alarm notification.

There is at least one microphone 1132 to detect either said exist alarm sound 1102 directly, or said re-generated alarm sound 1122, as well as said optional background audio sound in case of an alarm event.

There is a combination of hardware 1134 and software 1136 to perform functions such as, amplification, frequency filtering and comparing said alarm detection signal with reference data to identify said alarm sound.

There is a control method 1138, through keypad for example, to setup remote user's ID, the phone number for example, as contact number in case of an alarm event, to toggle between alarm or normal mode for the purpose of power saving and preventing false alarm during disarmed period, or automatically toggling through detecting said armed and disarm sound pattern from said exist alarm to minimize attention care.

Upon the detection of said alarm signal, a phone circuitry 1142 is capable of automatically establishing a call through a telephone network 1170 to said remote user 1172 to notify said alarm event, wherein said phone call can be through other type of available communication network 1170 including but not limited to internet, cable, landline, voice or data link.

Said remote user 1172 can be an individual, a monitor center, a police station or any other user able to receive alert message from said telephone 1130 through any available communication network including but not limited to cellular, landline, Internet, voice or data link.

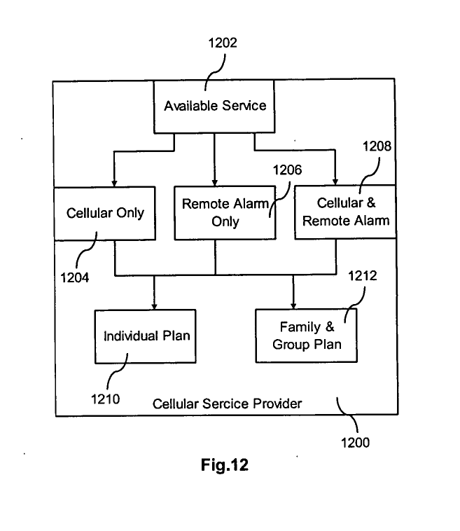

There is an optional combination of alarm sound level indication 1144 and sensitivity adjustment 1140 based on measured alarm sound for effective detection of different type of alarm sound in different level, frequency pattern and in different location. Referring to FIG. 12, A cellular services provider 1200 provides services 1202 including exist regular cellular communication services 1204, stand alone alarm remote notification 1206, or a combination of both 1208 through proving said alarm sound activated module, communication device as well as related network services described in other sections of above descriptions for the purpose of low cost alarm remote notifications wherein said services 1202 can be in a manner of individual 1210 or family & group plans 1212.

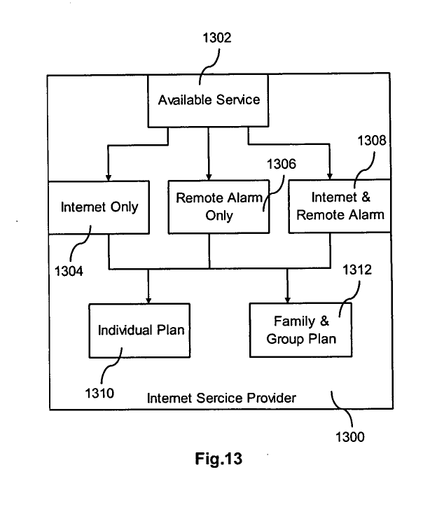

Referring to FIG. 13, A Internet services provider 1300 provides services 1302 including exist regular Internet communication services 1304, stand alone alarm remote notification 1306, or a combination of both 1308 through proving said alarm sound activated module, communication device as well as related network services described in other sections of above descriptions for the purpose of low cost alarm remote notifications wherein said services 1302 can be in a manner of individual 1310 or family & group plans 1312.

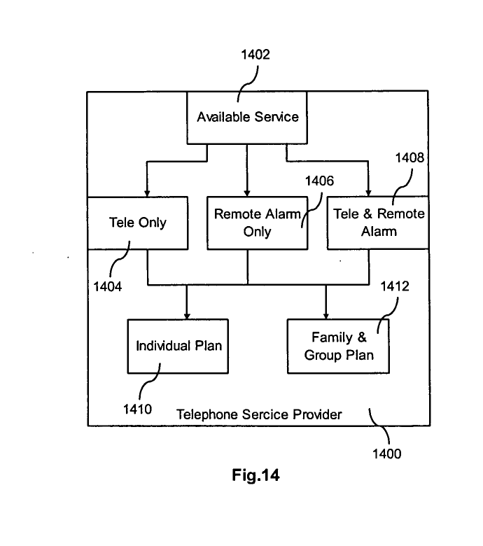

Referring to FIG. 14, A telephone services provider 1400 provides services 1402 including exist regular telephone communication services 1404, stand alone alarm remote notification 1406, or a combination of both 1408 through proving said alarm sound activated module, communication device as well as related network services described in other sections of above descriptions for the purpose of low cost alarm remote notifications wherein said services 1402 can be in a manner of individual 1410 or family & group plans 1412.

What is claimed as being new and therefore desired to be protected by Letters Patent by the United States is as follows:

1. An alarm sound activated module, namely a sound module, capable of detecting the alarm sound in the protected premises of an exist alarm system, communicating with a near by communication device through either wire connection, wireless technique or with another sound module through re-generated alarm sound, for establishing a path to notify a remote user of said alarm event, wherein said path for notification can be through any type of available communication network including, but not limited to cellular, landline, internet, cable, voice or data link, wherein said exist alarm can be any type of alarm systems capable of generating alarm sound in case of an alarm event including but not limited to indoor, outdoor security alarm, smoke detector alarm, as well as vehicle security alarm, wherein said remote user can be an individual, a monitor center, a police station or any other user capable of receiving alert message from said communication device through any available communication network including but not limited to cellular, landline, internet, cable, voice or data link.

2. The sound activated module of claim 1, a secondary sound module for example, capable of detecting said exist alarm sound and notifying other sound module or communication device through re-generated alarm sound further comprising:
a) a enclosure of sound module placed close to said exist alarm, either attached to the alarm sound source, or placed on close by desktop, wall or top ceiling mounted, to effectively picking up said exist alarm sound;
b) at least one sound reactive device, a microphone for example, to detect said exist alarm sound directly and optional background audio sound in case of an alarm event;
c) a combination of hardware and optional software to perform sound recognition process on said detected alarm signal such as amplification, frequency filtering, comparing with reference data to identify said alarm sound;
d) a speaker, or siren, to re-generate a secondary alarm sound in response to said exist alarm sound to notify other near by sound module and communication device of said alarm event, wherein said re-generated alarm sound can be adjusted to a desired level and frequencies for effective reception by other said devices at a convenient and securer location;
e) an optional control method, such as a button or switch, to select said remote user's ID, stored in said near by communication device, the user's phone number for example, as next to call number in case of an alarm event, to toggle between normal or alarm mode for power saving and preventing false alarm, or to toggling automatically through recognition of armed and disarmed sound of said exist alarm for minimum attention care;
f) an optional alarm sound level indication and sensitivity adjustment based on measured alarm sound for effectively detecting different type of alarm sound at different location;
g) an optional AC power supply to maintain said alarm detection functions, extend battery life and preventing the need of frequently charging or replacing batteries.

3. The sound module of claim 1, a wireless sound module, capable of detecting said exist alarm sound directly, or said re-generated alarm sound, communicating with said communication device through wireless technique to notifying said alarm event further comprising:
a) a enclosure of sound module placed close to said exist alarm, either attached to the alarm sound source, on placed on near by desktop, wall or top ceiling mounted, for effectively detecting said exist alarm sound;
b) at least one sound reactive device, a microphone for example, to detect said exist alarm sound, or said re-generated alarm sound, as well as optional background audio sound in case of an alarm event;
c) a combination of hardware and optional software to perform process on said detected alarm signal such as amplification, frequency filtering, comparing with reference data to identify said alarm sound and converting it into control and optional audio signal;
d) a wireless device, including but not limited to Bluetooth, WiFi, or other wireless technique, to send corresponding alarm detection signal to said near by communication device for establishing a communication link to notify said remote user of said alarm event;
e) an optional control method, such as a button or switch, to select said remote user's ID, stored in said near by communication device, the user's phone number for example, as next to call number in case of an alarm event, to toggle between normal or alarm mode for power saving and preventing false alarm, or toggling automatically through recognition of armed and disarmed sound of said exist alarm to minimize attention care;
f) an optional combination of alarm sound level indication and sensitivity adjustment based on measured alarm sound for effectively detecting different type of alarm sound at different location;
g) an optional AC power supply to maintain said alarm detection function, extend battery life and preventing frequently charging or replacing battery.

4. The sound activated module of claim 1, a primary sound module for example, capable of detecting said exist alarm sound, or said re-generated alarm sound, communicating with said near by communication device, a cellular phone for example, through wire connection further comprising:
a) at least one sound reactive device, a microphone for example, to detect said exist alarm sound, or said re-generated alarm sound, as well as optional background audio sound in case of an alarm event;
b) a combination of hardware and optional software to perform process on said detected alarm sound signal such as amplification, frequency filtering, comparing with reference data to identify said alarm sound and converting it into control and optional audio signal;
c) a plug-in connector capable of connecting with the interface, the hands free call interface for example, on a commonly available cellular phone for sending said detected alarm signal to said cellular phone for establishing a call to notify said remote user of the alarm event, wherein the line assignment on said plug-in connector, the call initializing and audio signal lines for example, is compatible with said cellular phone interface for properly signal routing;
d) an optional control method, such as a button or switch, for selecting said remote user's ID stored in said near by cellular phone, the user's phone number for example, as next to call number in case of an alarm event, to toggle between normal or alarm mode for power saving and preventing false alarm, or toggling automatically through recognition of armed and disarmed sound pattern of said exist alarm to minimize attention care;
e) an optional combination of alarm sound level indication and sensitivity adjustment based on measured alarm sound for effectively detecting different type of alarm sound at different location;
f) an optional AC power supply to maintain said alarm function, extend battery life and preventing frequently charging or replacing battery.

5. The communication device of claim 1, a commonly available cellular phone for example, capable of communicating with said sound activated module through wire connection further comprising:
a) a commonly available interface on said cellular phone, the hands free call interface for example, capable of communicating with said sound module through a plug-in connector to receive control and optional audio signal, wherein the line assignment on said interface, the call initializing and audio lines for example, is to be matched by said plug-in connector from the sound module for properly signal routing;
b) a control method, through keypad for example, to set up said remote user's ID, the phone number for example, as next to call number in case of an alarm event;
c) a cellular circuitry for establishing a phone call, similar to making a hands free call, to notify said remote user of said alarm event through cellular network upon the detection of said alarm signal on said interface from said sound module;
d) an optional method of continuously sending said background audio signal, similar to hands free call, to said remote user for alarm monitoring;
e) an optional AC power supply to maintain said alarm function, extend battery life, and preventing frequently charging or replacing battery, or even better to use lower cost battery instead of using those expensive re-chargeable type on regular cellular phone.

6. The communication device of claim 1, a cellular phone for example, capable of communicating with said sound activated module through wireless technique further comprising:
a) a wireless device, including but not limited to Bluetooth, WiFi, or other wireless technique, capable of communicating with said sound module with similar type of wireless technique to receive said control and optional audio signal;
b) a control method, a keypad for example, to setup said remote user's ID, the phone number for example, as next to call number in case of an alarm event;
c) a cellular circuitry for establishing a call, similar to making a hands free call, to notify said remote user of said alarm event through cellular network upon receiving said alarm detection signal from said sound module through said wireless device;
d) an optional method of continuously sending said background audio signal, similar to that in a hands free call, to said remote user for alarm event monitoring;
e) an optional AC power supply to maintain said alarm detection function, extend battery life, and preventing frequently charging or replacing battery, or even better to use lower cost battery instead of using those expensive re-chargeable type used for regular cellular phone.

7. The sound activated module of claim 1, capable of detecting either said exist alarm sound, or said re-generated alarm sound, communicating with said communication device, a cellular phone for example, through wire connection further comprising:
a) at least one sound reactive device, a microphone for example, to detect said exist alarm sound, or regenerated alarm sound, as well as optional background audio sound in case of an alarm event;
b) a combination of hardware and optional software to perform process on said detected alarm sound signal such as amplification, frequency filtering, comparing with reference data to identify said alarm sound and converting it into control and optional audio signal;
c) an electro-mechanic gripper, driven by a mechanic force, a motor or magnetic controlled by said alarm detection signal for example, for holding the body of a general cellular headset connecting with said cellular phone through a plug-in connector, and to press on the call/receive button on said headset in response to said alarm detection signal for initializing a call on said cellular phone to notify said remote user of said alarm event, wherein said cellular headset is capable of optionally picking up background audio sound for alarm monitoring;
d) an optional control method, such as a button or switch, for selecting said remote user's ID, stored in said near by cellular phone, the phone number for example, as next to call number in case of an alarm event, to toggle between normal or alarm mode for power saving and preventing false alarm, or toggling automatically through recognition of armed and disarmed sound pattern of said exist alarm to minimize attention care;
e) an optional combination of alarm sound level indication and sensitivity adjustment based on measured alarm sound for effectively detecting different type of alarm sound at different location;
f) an optional AC power supply with indication of power condition to maintain said alarm detection function, extend battery life and preventing frequently charging or replacing the battery.

8. The sound activated module of claim 1, capable of detecting either said exist alarm sound, or a secondary re-generated alarm sound, communicating with said communication device, a cellular phone for example, through wireless technique further comprising:
a) at least one reactive device, a microphone for example, to pick up said exist alarm sound, or said re-generated alarm sound, as well as optional background audio sound in case of an alarm event;
b) a combination of hardware and optional software to perform process on said detected alarm signal such as amplification, frequency filtering, comparing with reference data to identify said alarm sound and converting it into control and optional audio signal;
c) an electro-mechanic gripper, driven by a mean of mechanic force, a motor or magnetic controlled by said alarm detection signal for example, for holding the body of a general Bluetooth, WiFi or other wireless cellular headset and to pressing on the call/receive button in response to said alarm detection signal for initializing a call on said cellular phone communicating with said wireless headset with similar wireless technique to notify said remote user of said alarm event, wherein said headset is capable of optionally picking up background audio sound for alarm monitoring;
d) an optional control method, such as a button or switch, for selecting said remote user's ID stored in said near by cellular phone, the user's phone number for example, as next to call number in case of an alarm event, to toggle between normal or alarm mode for power saving and preventing false alarm, or toggling automatically through recognition of armed and disarmed sound pattern of said exist alarm to minimize attention care;
e) an optional combination of alarm sound level indication and sensitivity adjustment based on measured alarm sound for effectively detection of different type of alarm sound in different location;
f) an optional AC power supply with indication of power condition to maintain said alarm detection function, extend battery life and to prevent the need of frequently charging the battery.

9. An enclosure of module, a cellular alarm device, to combine said sound module and communication device of claim 1, wherein said communication device is a cellular circuitry further comprising:
a) a least one sound reactive device, a microphone for example, for detecting said exist alarm sound, or said re-generated alarm sound, as well as an optional background audio sound in case of an alarm event;
b) a combination of hardware and software to process said detected alarm sound signal such as amplification, frequency filtering, comparing with reference data to identify said alarm sound and converting it into control and optional audio signal;
c) a control method, a keypad for example, to setup said remote user's ID, the phone number for example, as next to call in case of said alarm event, to toggle between normal or alarm mode to save power, or toggling automatically through recognition of the armed and disarmed sound pattern from said exist alarm to minimize attention care;
d) a cellular circuitry for establishing a call to notify said remote user of said alarm event through cellular network upon the detection of said alarm signal;
e) an optional combination of alarm sound level indication and sensitivity adjustment based on measured alarm sound for effectively detection of different type of alarm sound in different location;
f) an optional method of continuously sending said background audio signal to said remote user for alarm monitoring;
g) an option of simplifying said cellular circuitry as for the purpose of alarm notification only for device and network cost reduction by eliminating unnecessary functions from a regular cellular phone including but not limited to utilizing narrower cellular channel bandwidth, ignore incoming call, as well as to use smaller phone screen;
h) an optional AC power supply with power condition indication to maintain said alarm detection, extend battery life and preventing frequently charging the battery, or even better to make use of lower cost battery other than those expensive re-chargeable battery used by regular cellular phone.

10. The sound module of claim 1, capable of picking up either said exist alarm sound, or re-generated alarm sound, communicating with said communication device, a computer for example, through wire connection further comprising:
a) at least one sound reactive device, a microphone for example, for detecting said exist alarm sound, or re-generated alarm sound, as well as optional background audio sound in case of an alarm event;
b) a combination of hardware and optional software to perform tasks such as amplification, frequency filtering, comparing said alarm detection signal with reference data to identify said alarm sound and converting it into control and optional audio signal;
c) a connector compatible with the interface on said computer, the USB interface for example, to receive supply power and to send said alarm detection signal to said computer for establishing a communication link to notify a remote user of said alarm event.
d) an optional control method to toggle between normal or alarm mode for power saving and preventing false alarm, or toggling automatically through recognition of armed and disarmed sound pattern of said exist alarm to minimize attention care;
e) an optional combination of alarm sound level indication and sensitivity adjustment based on measured alarm sound for effective detection of different type of alarm sound in different level, frequency pattern and in different location;

11. The communication device of claim 1, a computer for example, capable of communicating with said sound module through wire connection further comprising:
a) an interface, the USB port example, to provide supply power to, communicate with, and to receive said alarm detection signal from said sound module;
b) a combination of hardware and software to control signal routing on said USB interface and to perform process on said alarm detection signal such as amplification, frequency filtering, comparing with reference data to identify said alarm sound and converting it into control and optional audio signal;
c) a control method, though keyboard for example, for selecting said remote user's ID, the user's phone number or Internet address for example, as next to contact number in case of an alarm event, to toggle between normal or alarm mode for preventing false alarm, or toggling automatically through recognition of armed and disarmed sound pattern of said exist alarm to minimize attention care;
d) an optional combination of alarm sound level indication and sensitivity adjustment based on measured alarm sound for effective detection of different type of alarm sound in different level, frequency pattern and in different location;
e) a communication circuitry for establishing a communication link to notify said remote user of said alarm event in responds to said alarm detection signal, wherein said communication link can be through any type of available communication network including but not limited to internet, cable, landline, cellular, voice or data link.

12. The communication device of claim 1, a computer for example, capable of communicating with said sound module through wireless technique further comprising:
a) a wireless device, including but not limited to Bluetooth, WiFi, or other wireless device, either plugged-in from a commonly available interface, the USB port for example, or built-inside said computer, to communicate with said sound module with similar wireless technique and to receive said alarm detection signal from said sound module;
b) a combination of hardware and software to control said wireless device for properly signal routing, performing process on said detected alarm signal such as amplification, frequency filtering, comparing with reference data to identify said alarm sound and converting it into control and optional audio signal;
c) a control method, through keyboard for example, for selecting said remote user's ID, the user's phone number or internet address for example, as next to contact number in case of an alarm event, to toggle between normal or alarm mode for preventing false alarm, or toggling automatically through recognition of armed and disarmed sound pattern of said exist alarm to minimize attention care;
d) an optional combination of alarm sound level indication and sensitivity adjustment based on measured alarm sound for effective detection of different type of alarm sound in different level, frequency pattern and in different location;
e) a communication circuitry for establishing a communication link to notify said remote user of said alarm event in responds to said alarm detection signal, wherein said communication link can be through any type of available communication network including but not limited to Internet, cable, landline, cellular, voice or data link.

13. An enclosure to combine said sound module and communication device of claim 1 for alarm remote notification, wherein said communication device is a computer further comprising:
a) at least one sound reactive device, a microphone for example, for detecting said exist alarm sound, re-generated alarm sound, as well as optional background audio sound in case of an alarm event;
b) a combination of hardware and software to perform process on said detected alarm sound signal such as amplification, frequency filtering, comparing with reference data to identify said alarm sound and converting it into control and optional audio signal;
c) a control method, through keyboard for example, for selecting said remote user's ID, the phone number or internet address for example, as next to contact number in case of an alarm event, to toggle between normal or alarm mode for preventing false alarm, or toggling automatically through recognition of armed and disarmed sound pattern of said exist alarm to minimize attention care;
d) an optional combination of alarm sound level indication and sensitivity adjustment based on measured alarm sound for effective detection of different type of alarm sound in different level, frequency pattern and in different location;
e) a communication circuitry for establishing a communication link to said remote user to notify said alarm event in responds to said alarm detection signal, wherein said communication link can be through any type of available communication network including but not limited to internet, cable, landline, cellular, voice or data link.

14. The sound module of claim 1, capable of picking up either said exist alarm sound, or re-generated alarm sound, communicating with said communication device, a telephone for example, through wire connection further comprising:
a) at least one sound reactive device, a microphone for example, to detect said exist alarm sound, or re-generated alarm sound, as well as optional background audio sound in case of an alarm event;
b) a combination of hardware and optional software to perform process on said detected alarm signal such as amplification, frequency filtering, comparing with reference data to identify said alarm sound and converting it into control and optional audio signal;
c) a wire connector compatible with an interface on said telephone, the USB port for example, to receive supply power and to send said alarm detection signal to said telephone for establishing a communication link to notify a remote user of said alarm event;
d) an optional control method, a button or switch for example, to toggling between normal or alarm mode for power saving and preventing false alarm, or toggling automatically through recognition of armed and disarmed sound pattern of said exist alarm to minimize attention care;
e) an optional combination of alarm sound level indication and sensitivity adjustment based on measured alarm sound for effective detection of different type of alarm sound in different level, frequency pattern and in different location.

15. The communication device of claim 1, a telephone for example, capable of communicating with said sound module through wire connection further comprising:
a) an interface, a USB port example, to provide supply power to, communicate with, and to receive said alarm detection signal from said sound module;
b) a combination of hardware and software to control said USB port for properly signal routing, performing process on said detected alarm signal such as amplification, frequency filtering, comparing with reference data to identify said alarm sound and converting it into control and optional audio signal;
c) a control method, a keypad for example, for setting up said remote user's ID, the phone number for example, as next to call number in case of said alarm event, to toggling between normal or alarm mode for power saving and preventing false alarm, or toggling automatically through recognition of armed and disarmed sound pattern of said exist alarm to minimize attention care;
d) a telephone circuitry for establishing a communication link to said remote user to notify said alarm event in responds to said alarm detection signal, wherein said communication link can be through any type of available communication network including but not limited to landline telephone, internet, cable, voice or data link;
e) an optional combination of alarm sound level indication and sensitivity adjustment based on measured alarm sound for effective detection of different type of alarm sound in different level, frequency pattern and in different location.

16. The communication device of claim 1, a telephone for example, capable of communicating with said sound module through wireless technique further comprising:
a) a wireless device, including but not limited to Bluetooth, WiFi, or other short range wireless technique, either plugged-in an interface, the USB port for example, or built-inside said telephone, to communicate with said sound module with similar wireless technique, and to receive said alarm detection signal from said sound module;
b) a combination of hardware and software to control said wireless device for properly signal routing, to perform process on said detected alarm signal such as amplification, frequency filtering, comparing with reference data to identify said alarm sound and converting it into control and optional audio signal;
c) an control method, a keypad for example, for setting up said remote user's ID, the phone number for example, as next to call number in case of said alarm event, to toggling between normal or alarm mode for power saving and preventing false alarm, or toggling automatically through recognition of armed and disarmed sound pattern of said exist alarm to minimize attention care;
d) a telephone circuitry for establishing a communication link to said remote user to notify said alarm event in responds to said alarm detection signal from said sound module, wherein said communication link can be through any type of available communication network including but not limited to landline telephone, internet, cable, voice or data link;
e) an optional combination of alarm sound level indication and sensitivity adjustment based on measured alarm sound for effective detection of different type of alarm sound in different level, frequency pattern and in different location;

17. An enclosure to combine said sound module and communication device of claim 1, wherein said communication device is a telephone circuitry further comprising:
a) at least one sound reactive device, a microphone for example, for detecting said exist alarm sound, or said re-generated alarm sound, as well as optional background audio sound in case of an alarm event;
b) a combination of hardware and software to perform processing on said detected alarm signal such as amplification, frequency filtering, comparing with reference data to identify said alarm sound and converting it into control and optional audio signal;
c) an control method, a keypad for example, for setting up said remote user's ID, the phone number for example, as next to call number in case of said alarm event, to toggling between normal or alarm mode for power saving and preventing false alarm, or toggling automatically through recognition of armed and disarmed sound pattern of said exist alarm to minimize attention care;
d) a telephone circuitry for establishing a communication link to said remote user to notify said alarm event in responds to said alarm detection signal from said sound module, wherein said communication link can be through any type of available communication network including but not limited to landline telephone, cable, internet, voice or data link;
e) an optional combination of alarm sound level indication and sensitivity adjustment based on measured alarm sound for effective detection of different type of alarm sound in different level, frequency pattern and in different location.

18. A method of business to provide alarm remote notification services with said alarm sound activated module of claim 1 in combination with other conventional communication service comprising:
a) a cellular service provider proving said alarm sound module along with cellular remote alarm notification service in combination with regular cellular phone service in an individual, family, or group plan;
b) a internet service provider providing said sound module along with Internet remote alarm notification service in combination with regular Internet service in an individual, family, or group plan;
c) a telephone service provider providing said sound module along with landline remote alarm notification service in combination with regular landline telephone service in an individual, family, or group plan.
